(19) United States
(12) Patent Application Publication
(10) Pub. No.: US 2015/0024705 A1
(43) Pub. Date: Jan. 22, 2015

(54) RECORDING AND REPORTING DEVICE, METHOD, AND APPLICATION

(71) Applicant: Habib Rashidi, Bellevue, WA (US)

(72) Inventor: Habib Rashidi, Bellevue, WA (US)

(21) Appl. No.: 14/265,314

(22) Filed: Apr. 29, 2014

Related U.S. Application Data
(60) Provisional application No. 61/818,292, filed on May 1, 2013.

(51) Int. Cl. H04W 4/22; H04N 5/781; G11B 31/00

(52) U.S. Cl. CPC H04W 4/22; G11B 31/006; G11B 31/003; H04N 5/781
USPC 455/404.2

(57) ABSTRACT

A method and/or a computer readable medium and a computer-executable set of instructions on the computer readable medium, and/or a product or processing system such as a handheld communication device or computer, for carrying out the method, the method allowing a user to initiate capturing images during an experience such as a driving experience and submitting an electronic communication containing at least captured images for a threshold duration before and/or after detecting a threshold magnitude motion, such as one emulating a car accident. The electronic communication can be configured to be sent to a predestinated destination such as an insurance agent, emergency respondent, family member, employer, or any other destination, and may include additional information such as accident location, user information, and vehicle information. The processing system display may provide the user the option to, or the processing system may automatically, call a desired destination such as an emergency respondent. The processing system may respond to computer-executable instructions to delete from a threshold history of the captured image as the image capture device thereof records images to preserve memory space, keeping the most recent threshold duration. The processing system may respond to computer-executable instructions to continue recording after the threshold magnitude motion is detected for a threshold duration prior to submitting the captured image. The display of the processing system may include a user-selectable panic object to allow manual submission of a threshold duration of the image captured without the processing system having detected the threshold magnitude motion.

### BACKGROUND

1. Technical Field

The present disclosure relates to the field of image recording devices and software, more particularly, to recording devices for live recording of vehicle or vessel travel history and/or travel, accident, and/or other observation experience.

2. Description of the Related Art

For clarity of description and purposes of brevity, throughout this application, the present disclosure will be discussed in relation to live surveillance, and/or image or view recording associated with “automobile” or “vehicle” operation without any intention to limit the scope of the present disclosure; however, it is understood that the present disclosures and various described and not described embodiments thereof, may just as well be used in other applications such as aircraft, ships, boats, motorcycles, bicycles, and/or any other vehicle, vessel, and/or other transportation apparatus and/or device. Furthermore, it is understood the present disclosure may not necessarily be limited to transportation apparatus and devices, and may be used in relation to any circumstance or situation in which live recorded surveillance and/or monitoring is desired or may be beneficial.

Frequently automobile accidents are unreported, resulting in large losses to stakeholders involved, including vessel or vehicle owners, insurance companies, employers, parents of vehicle owner, businesses and any other relevant person or entity having an interest in the rights and/or liabilities involved. Business examples of such under-reporting include, among other cases, taxi and limo industries, trucking industry, delivery businesses, and any other business or industry in which automobile fleets are operated by employees and/or subordinates.

For example, the cost commercial automobile insurance companies suffered in direct losses in Washington State alone totaled about $225,000,000.00 in year 2010. The primary contributor of claim processing is not receiving the claim in a timely manner, usually best to be received promptly following an incident. Accident location is usually missing in reports received for example because location was unknown or signs were not visible due to poor lighting or simply unfamiliar territory.

Furthermore, when other parties file a report sooner than the insured party or file a suit, their attorneys use discrepancies between the accounts of the accidents against a taxi or limousine dispatch company. Claims costs increase when information is incomplete and delayed. Most accident victims hire an attorney out of fear of not getting a fair compensation. Further, claims departments are looking for information lending to clear liability. As more information becomes available, the allocated reserve amount will vary depending on the type of information.

Businesses and insurance companies are not the only entities suffering from under-reporting or poor reporting of automobile accidents. Similarly, regular drivers often are involved in automobile accidents where witnesses are scarce or not available at all. Therefore, these drivers and their insurance companies are faced with a prolonged and costly process of reconciling between the accounts of the parties involved in the accident, often requiring an attorney to aid in the process and further adding to expenses.

In other instances, parents of young drivers, for example teenage drivers, often face the challenge of their children not being forthright about what happened in an accident. In such cases, parents are stuck between dealing with insurance companies and evidence or testimony contradicting that of the children, further making the resolution process more frustrating and potentially costly.

All above cases may or may not involve another vehicle. In the latter case, stakeholders further lack information necessary for them to make the proper decision and be made whole or pay only the required liability compensation.

### BRIEF SUMMARY

In one embodiment, a method configured to be implemented on a processing system having a processor, memory, and image-capture device, a motion sensing component, and a display, includes capturing an image for a duration, detecting a motion of a threshold magnitude, and electronically submitting the captured image for at least the duration to a destination in response to detecting the motion of the threshold magnitude or upon a user-instructed event.

According to one aspect, the capturing step includes displaying a user-selectable object for initiating image capturing. According to one aspect, the captured image is stored on the memory temporally and subsequent to submittal to destination, the captured image is deleted from the memory.

According to one aspect, the duration includes a threshold duration prior to the motion sensing component detecting the motion of the threshold magnitude until a threshold duration subsequent to the motion sensing component detecting the motion of the threshold magnitude.

According to one aspect, the threshold magnitude is a user-selectable magnitude.

According to one aspect, the method further includes detecting a geographic position of the processing system and electronically submitting the geographic position to the destination.

According to one aspect, the processing system includes a handheld communication device and the method further includes blocking incoming communication to the device. According to one aspect, the capturing step includes capturing an image for a first duration and continuing to capture the image for a second duration, wherein upon beginning to capture the image for the second duration at least a portion of the image captured during the first duration is purged or deleted from memory.

According to one aspect, the method further includes displaying a user-selectable object to initiate communication with at least one destination such as an emergency respondent, upon detecting the motion of the threshold magnitude.

According to one aspect, the user-selectable event includes the user selecting a manual submit object, subsequent to such selection the method including submitting image captured from a threshold duration prior to the user selecting the manual submit object to a threshold duration subsequent to the user selecting the manual submit object.

In another embodiment, a system includes a video capture device configured to capture video images, a global positioning system (GPS) device configured to determine GPS coordinates identifying the location of the video capture device, a motion detecting component, a display, a server for receiving and servicing requests for electronic communication such as electronic mail, a general-purpose processor in digital communication with the video capture device, the GPS device, the motion and the display, the general purpose processor configured to digitally communicate with the video capture device to initiate capturing images for a threshold duration and to digitally communicate with the motion detecting component and upon detecting a motion of a threshold magnitude, the general-purpose processor is configured to electronically communication with the server to submit an electronic message comprising at least a portion of the captured image.

According to one aspect, the processor in cooperation with the video capture device limits the duration of the captured image submitted to a threshold duration of image capture prior to the motion detecting component detecting the motion to a threshold duration of image capture subsequent to the motion detecting component detecting the motion.

According to one aspect, the system further includes a graphics processor in digital communication with the general-purpose processor, wherein processer communicates with the graphics processor to display a user-selectable external communication object on the display upon the motion detecting component detecting the motion.

According to one aspect, the system further includes a memory unit in digital communication with the processor, wherein the processor communicates with the video capture device to capture images on the memory for a first threshold duration followed by a second threshold duration, the processor communicating with the memory unit to delete or purge at least a portion of the first threshold duration when the second threshold duration begins.

According to one aspect, the motion detecting component includes an accelerometer.

According to one aspect, the processor communicates with the graphics processor to display a panic or manual submit object on the display, upon selection of the panic object the processor communicating with the server to submit a threshold duration of the image captured by the video capture device via electronic communication.

According to one aspect, the processor communicates with the GPS device and the server to include in the electronic message GPS coordinates or location of the video capture device.

In yet another embodiment, a device includes a computer-readable medium, and computer-executable instructions on the computer-readable medium for causing a computer having a processor and a display to perform the method of any one of the embodiments of this disclosure.

According to still another embodiment, a method configured to be implemented on a processing system having a processor, memory, communication components, includes capturing information for a duration, detecting an incident and electronically storing or submitting the captured information in response to detecting the incident.

### BRIEF DESCRIPTION OF THE SEVERAL VIEWS OF THE DRAWINGS

FIG. 1 is a flowchart displaying a method for recording and reporting according to one embodiment.

FIGS. 2 through 6 are screen shots of an application for recording and reporting according to one or more embodiments.

FIG. 7 is a flowchart displaying monitoring steps of the method of FIG. 1 according to one aspect.

FIGS. 8 and 9 are screen shots of an application for recording and reporting according to one or more embodiments.

FIG. 10 is a flowchart displaying help request steps of the method of FIG. 1 according to one aspect.

FIGS. 11 through 15 are screen shots of an application for recording and reporting according to one or more embodiments.

FIG. 16 is a flowchart displaying monitoring and reporting steps of the method of FIG. 1 according to one aspect.

FIGS. 17 and 18 are screen shots of an application for recording and reporting according to one or more embodiments.

FIG. 19 is a schematic demonstrating a memory preserving image-recording method according to one embodiment.

FIG. 20 is a schematic of an example system embodiment.

FIG. 21 is a schematic of an example system embodiment.

FIG. 22 is a screenshot of an application settings according to one embodiment.

### DETAILED DESCRIPTION

Embodiments of the present disclosure are described below in various forms including with reference to a flowchart format and step by step computing or mobile device graphical user interface (GUI) snapshots. For clarity of description and brevity, the embodiments are described in relation to a processing system such as a computer or handheld communication or mobile device GUI and infrastructure without any intention to limit the scope; it is understood that other embodiments may be configured for use with any computing or mobile device, and the corresponding operating system including, but not limited to, PCs and Windows®, Apple® Computers and the iOS® operating system, and/or mobile phones and any one or more of the Android®, iOS®, Windows®, and/or any other computing device or operating system.

Embodiments of the present disclosure may be implemented using the processing system based on the processing unit storing and/or processing a set of instructions for example in the form of a computer program and/or mobile device application. The processing system may include non-volatile memory such as Read Only Memory (ROM) and/or volatile memory such as Random Access Memory (RAM), DRAM, and/or SRAM, connected to the processing system's central processing unit, for initializing and performing other commands according the program or application instructions. Certain examples of processing systems and operation to execute methods according to the present disclosure are set forth toward the end of the present disclosure.

The disclosure that follows generally discusses methods comprising a series of steps that can be or are executed using a processing system. For purposes of brevity and clarity, the methods according to various embodiments may be described only with respect to the steps thereof and/or interacting with the processing unit of the processing system to bring about the disclosed steps when they are implemented and/or executed on the processing unit. It is understood that there are internal workings within components of the processing system that execute the corresponding method instructions.

Such interworking within the processing system components are generally described toward the end of the present disclosure as it pertains to certain examples; it is understood that embodiments of the present disclosure are not limited to the described methods and the processing system components and interactions thereof. However such embodiments and disclosure are provided to provide a thorough understanding of embodiments hereof without any intention to limit them to a particular processing system and/or methods of bringing about the advantageous aspects of embodiments described herein.

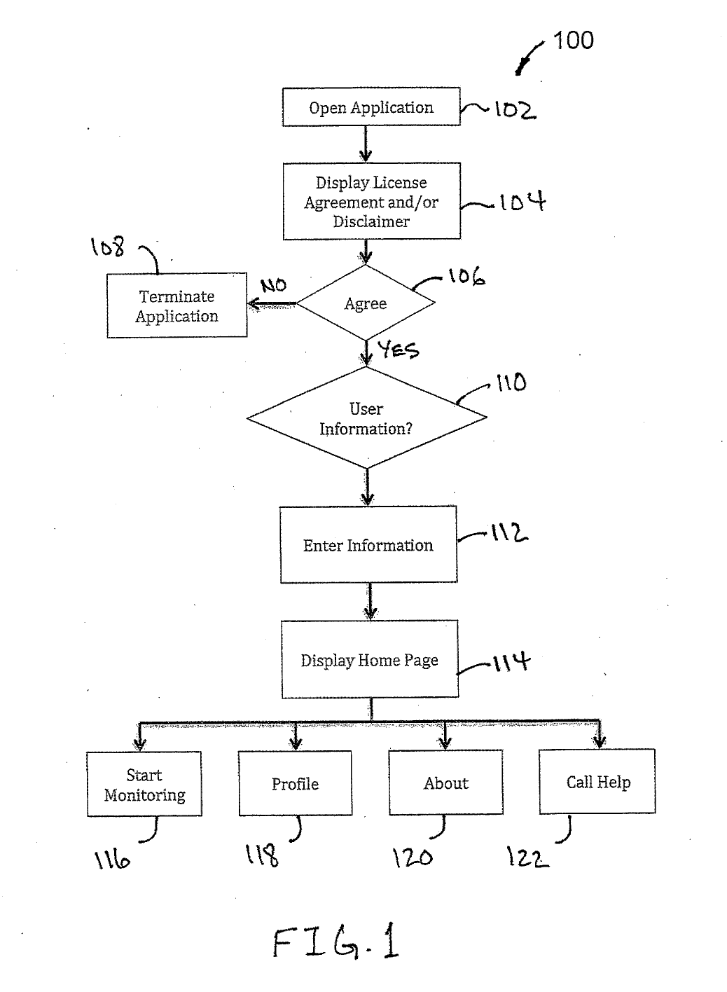

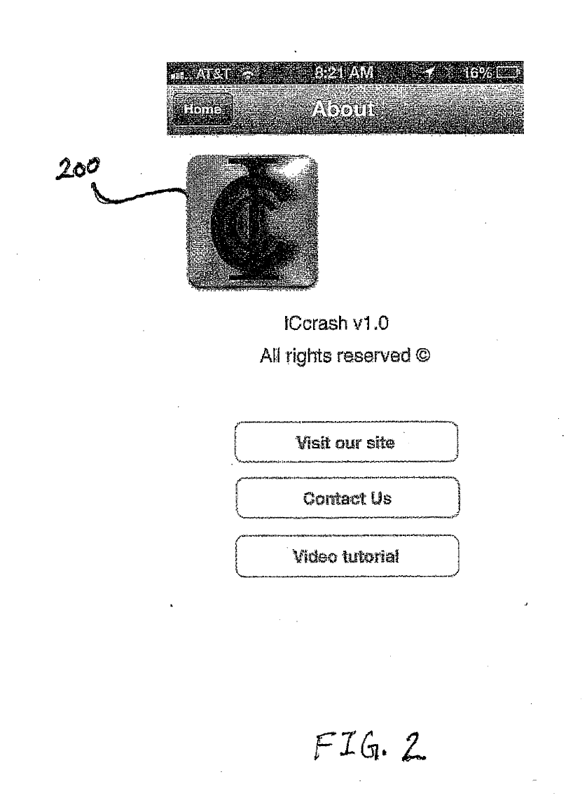

FIG. 1 is a flowchart illustrating a method 100 for recording and reporting of images and/or moving images according to one embodiment. According to one aspect, the method 100 comprises processing system readable and executable instructions such as a software application (“Application”) such as an Application 200 shown in FIG. 2 in accordance with an embodiment operable to be installed, launched, operated, and closed from an operating system platform and/or a processing unit thereof, such as a mobile device operating system and/or processing unit.

FIG. 2 shows the Application 200 based on an example icon that can be designed and associated with the underlying software code of the Application 200 for triggering launching the Application 200.

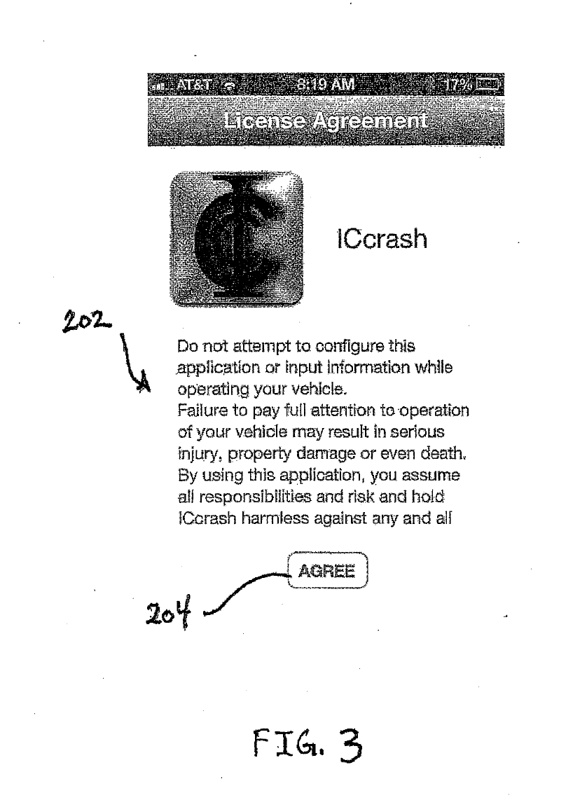

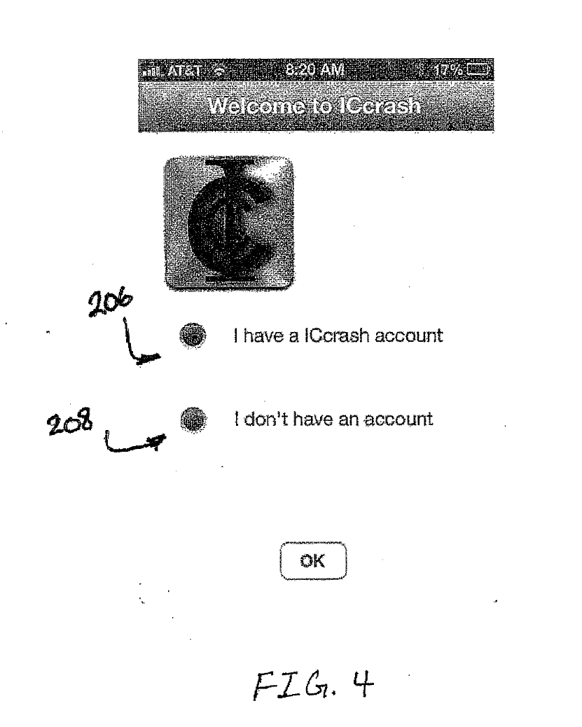

In one embodiment, as illustrated in FIG. 1, at step 102 of method 100, the user may launch the Application 200 illustrated in FIG. 2, by selecting the icon associated with it, for example by using an input device such as a touch-screen where the user by touch-clicking on it on a mobile device such as an iPhone® brand mobile device, opening the Application 200. In an aspect, once the Application 200 is launched or opened, it can be configured to display a license agreement and/or display message 202 illustrated in FIG. 3 as a precondition for the user to proceed to using the Application 200, at step 104 of method 100.

The message 202 is shown is an example and by no means is there any intention to limit the present disclosure to this specific message, and depending on the software provider and the specific legal and liability concerns the provider may have, the message and/or license agreement can be modified appropriately. It is further understood, the present disclosure is not limited by requiring a license and/or disclaimer message, however, such a message may serve the advantage of limiting liability for the software provider and/or notifying users of the parameters revolving around use of Application 200.

In embodiments that include message 202, the Application 200 at step 106 of method 100, can be configured to instruct the processing unit to display an object or prompt the user to verify agreement with the contents of the message. In one aspect, the Application 200 at step 106 can be configured to further display a verification object 204, which the user may select to verify agreeing to the message 202 contents. Should the user not select the verification object 204, the Application 200 can be configured to instruct the processing system's processing unit to operate and terminate the Application 200, or allow only Application termination as the user's alternative option, at step 108 of method 100. In another embodiment, instead of terminating the Application 200 may allow limited functionality of Application 200 precluding one or more of the features that follow from operating, in the event the license agreement is not accepted.

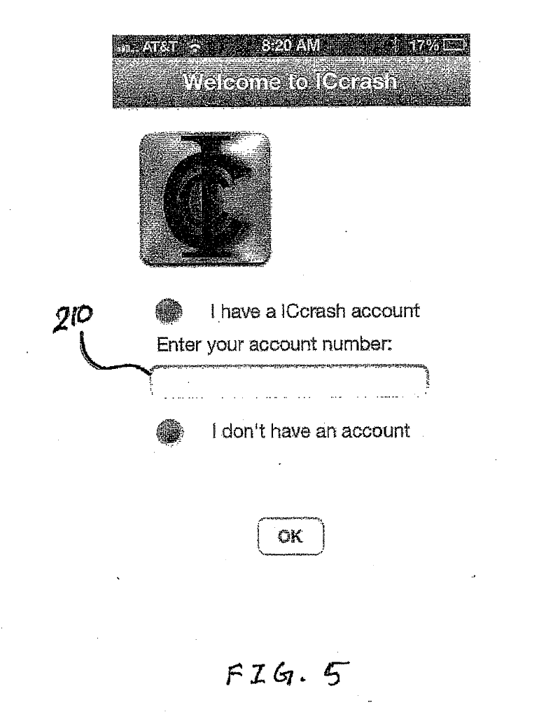

Depending on the particular embodiment, either after opening the Application 200 where step 104 is not included, or after the user clicking on the verification object 204 where step 104 is included, the Application 200 at step 110 of method 100 can be configured to instruct the processing unit to prompt the user for confirming a user Application information, such as account and/or password and/or vehicle identifier, at step 110. For example, as illustrated in FIG. 4, in one embodiment, the Application 200 may prompt the user to select one of two options, a first account-related prompt 206 that solicits an Application account number and/or passwords, and second account-related prompt 208 that prompts the user to convey the user does not have an account.

Should the user select the second account-related prompt 208, the Application 200 can be configured in one embodiment to guide the user through one or more forms, such as internet or remote server database or a file transfer protocol submittable form or forms, to allow the user to create a new account.

Any identity verification or log in method, such as biometric verification, fingerprint, or other method may be utilized in any embodiment. Input can be further provided through any other input method including but not limited to voice, gestures, or other manner of controlling selection or navigation of Application 200.

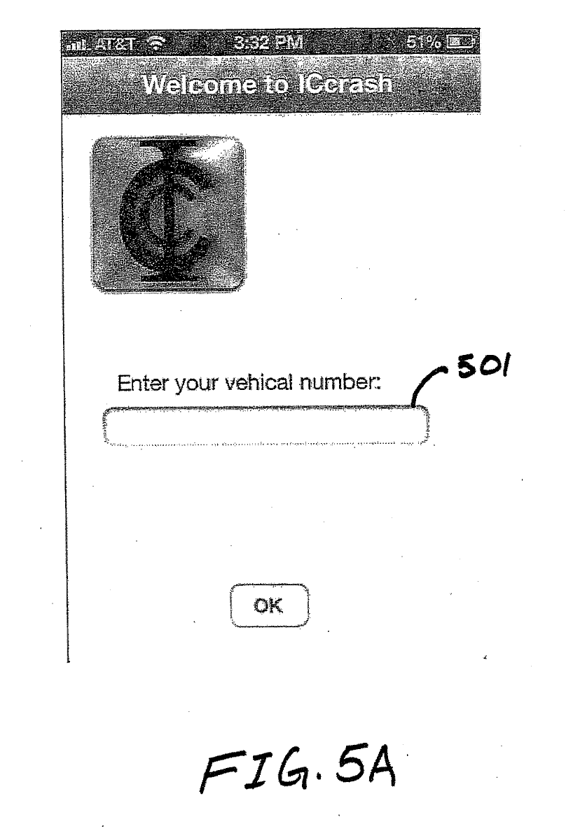

In one embodiment, for users who have an account, the user can select the first account-related prompt 206 and the Application 200 can be configured to instruct the processing unit to communicate with other chipset and/or display components of the processing system as described further below to display an account and/or password and/or other configurable field 210 as illustrated in FIG. 5. The user in one aspect would then enter the account and/or password information in the field 210 at step 112 of the method 100, to proceed to the Application 200 home page at step 114. In some embodiments, other entry fields may be provided at a particular page either at the same place as where the account information is entered or in the profile page or other suitable local or remote place. For example, other information may include name, vehicle, number, license number, or other suitable information. Upon entry or account formation, user information can be stored locally or on a remote server as discussed later in the application through electronic communication between a processing unit and a server.

In some embodiments, the account information may only be required to be entered the first time the Application 200 launches and be stored in memory or a remote server configured to be in electronic communication with the processing unit or handheld communication device, for future launches so the user does not have to enter it every time the Application 200 is launched.

In some embodiments, for example where a user has multiple vehicles, the Application 200 may be configured to instruct the processing unit to display a user-selectable or an entry field 501 shown in FIG. 5A, for the user to identify which vehicle is being used for example by entering the license plate number.

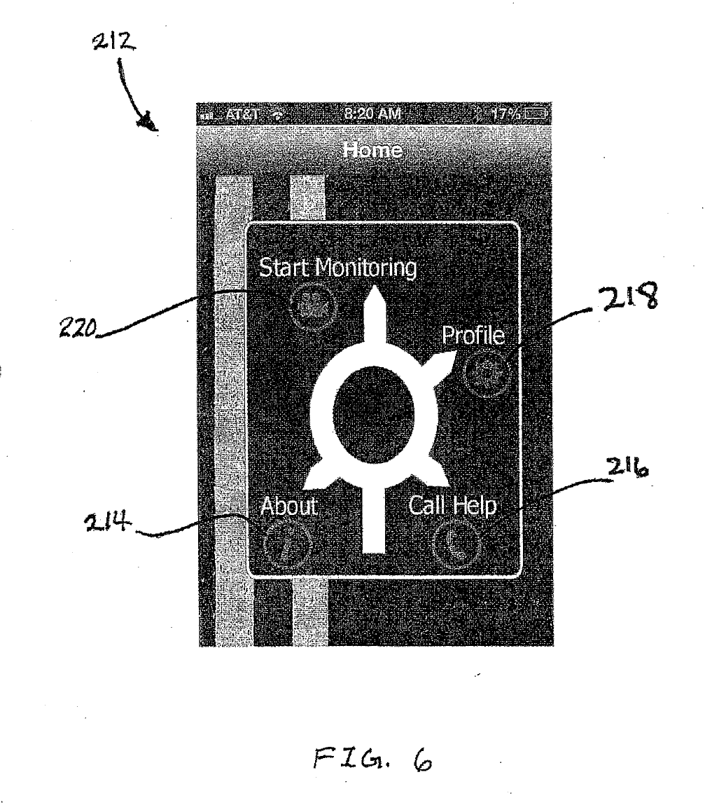

FIG. 6 illustrates one aspect of how a home page 212 may be configured. For example, in one embodiment, the home page 212 may include a number of user selectable prompts, such as icons, allowing the user to navigate through features of the Application 200. For example, in one aspect the Application 200 may include an about prompt 214, a call help prompt 216, a profile prompt 218, and a start-monitoring prompt 220. Similarly, the method 100 may include steps for the user selecting any one or more of these prompts, such as a step 116 for selecting the select monitoring prompt 220, a step 118 for selecting the profile prompt 218, a step 120 for selecting the about prompt 216, and/or a step 122 for selecting the call help prompt 216.

The user selecting such prompts via the processing system's input device, such as a touch screen device, would then prompt the processing unit of the system to operate and communicate with other processing unit components to implement the steps corresponding with these prompts.

In an aspect the Application 200 can be configured such that when the user selects the about prompt 216 at step 116, the user is directed to information related to the Application 200 workings, developers, the providing company, Application features, user selectable Application configuration features, link to a website, video tutorial or any other information for which the Application provider may wish to communicate or solicit user's input.

Non-limiting aspects of these home page 212 prompts will be described below with respect to particular embodiments for purposes of clarity and to provide examples for a thorough understanding of the present disclosure; however, it is understood that the home page in other embodiments may include other features or prompts, which the Application provider deems appropriate or useful for operation of the Application. All such alternative options are contemplated to be within the scope of the present disclosure.

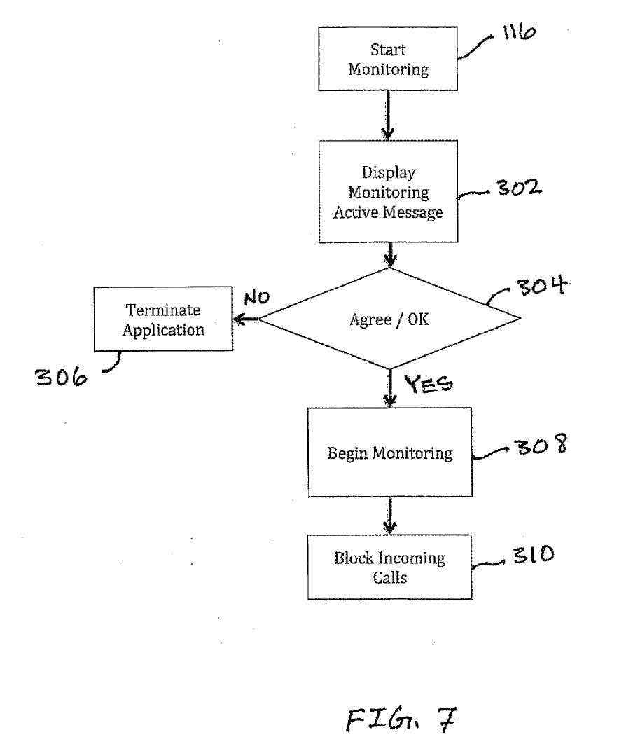

In one aspect, the Application 200 can be configured such that when the start monitoring prompt 220 is selected at step 116 of method 100, the Application 200 proceeds to instruct the processing unit to operating according to a method 300 illustrated in FIG. 7 for monitoring and recording at least a portion of the user's driving experience.

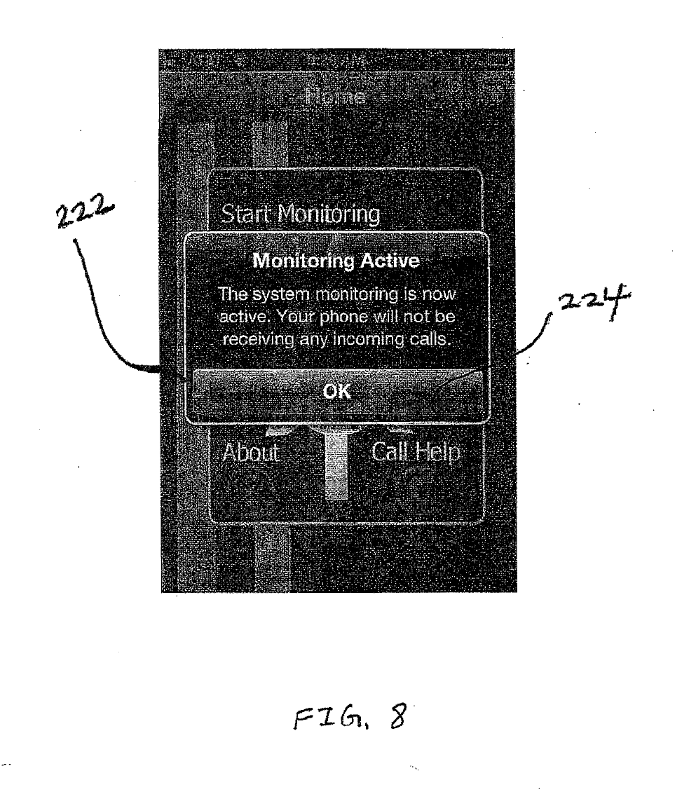

In one aspect, the method 300 includes instructing the processing unit to display a monitoring active message 222 such as the one illustrated in FIG. 8, at step 302 of the method 300. For example, the monitoring active message 222 may include a message to the user notifying the user that the Application 200 is monitoring the user's driving experience. At this juncture in the method 300 the Application 200 may be configured to instruct the processing unit to start monitoring or provide the user a user-selectable monitor confirmation prompt 224 for the user to select and confirm user desires the Application 200 begin monitoring the driving experience.

In embodiments in which the Application 200 is configured to automatically begin monitoring the user's driving experience upon user selecting the start monitoring prompt 116 without proceeding through a confirming method such as the confirming method 300, the Application 200 would instruct the processing unit to begin recording the user's experience through the mobile or handheld or other processing system device associated image recording device, for example a mobile phone camera. The camera associated with a mobile device serving as a platform for housing an operating and/or processing system on which the Application is installed, can include any form of a camera or image-recording device.

For example, in one embodiment, such a camera can include the mobile device's internal and as-manufactured camera. In another embodiment, such a camera can include the mobile device camera as complemented, supplemented, or otherwise enhanced or operated via a hardware, firmware, and/or software application lending toward the mobile and/or handheld and/or other processing system device image recording features including, but not limited to, its camera. For example, in some embodiments, the Application 200 may be configured to incorporate augmented reality protocols facilitating better location management.

In yet other embodiments, the camera feature may be independent of the mobile phone as-manufactured camera and it may be an external accessory and/or another software application providing for image recording using the mobile device.

In some embodiments, the Application 200 may be configured on a handheld device to always be active and begin monitoring automatically when the processing unit detects motion of the vehicle through the accelerometer, GPS, or compass components thereof. This may be an embodiment a fleet manager may find useful.

In embodiments in which the Application 200 is configured to prompt the user at 302 to confirm monitoring activation of the Application 200, the Application 200 will then begin such monitoring as described above upon user selecting an agree or “OK” prompt or object, or any other similar prompt at step 304 of method 300 for user to confirm user desires monitoring to begin. In such embodiments, once the user selects the confirmation prompt 304, the Application can be configured to instruct the processing unit to operate and begin, or affect beginning, monitoring at step 308 of the method 300. If the user does not wish to start monitoring the user may take no action or navigate to mobile device home screen or to other pages of the Application 200 or terminate the Application 200 at 306.

In another embodiment, the Application 200 can be configured to only allow those features or features, or features in a manner as allowed by the law. For example, in such an example embodiment, Application 200 may only allow incoming calls such as via hands-free headset or vehicle call system.

In some embodiments, as the Application provider may desire or deem of particular safety or economic value, the Application 200 can be configured to perform other functions simultaneously with driving experience monitoring. For example, in one embodiment, the Application 200 at step 310 of method 300 may be configured to instruct the processing unit to block incoming calls and/or text or e-mail messages while the Application 200 is monitoring driving experience. As discussed below, in some embodiments, incoming communication such as calls, texts, and/or e-mails may be allowed to continue to come in.

Such a feature can be beneficial especially for businesses involved in operating and managing a vehicle fleet, such as the taxicab, trucking, delivery, and/or limousine industry. In such industries, the employer has the incentive to improve fleet driving safety. With the advent and proliferation of mobile devices, and emerging promoting factor in improving safety is to avoid such devices when driving. Therefore, in an aspect of the present disclosure, the Application 200 can be configured to instruct the processing unit to prevent and/or block incoming calls and/or text or e-mail messages to the mobile device while the Application 200 is monitoring the user's driving experience. In other embodiments, incoming communication may continue to be allowed. It is understood the monitoring active message 222 is an example and in embodiments where incoming communication is allowed the message would be modified to suite the proper embodiment. In still other embodiments there may be no message displayed.

A video clip of an incident will help clear the liability immediately rather than collecting information over long durations of time and reconciling conflicting information, to decide who had the right away, and drivers will be motivated to behave much safer with a camera as witness

For clarity, whenever in this disclosure examples of beneficial uses of various embodiments are discussed, there is no intention to limit the scope of the present disclosure. For example, other applications may very well benefit and/or use the present disclosure embodiments in other manners. For example, the incoming call block function described above according to one embodiment, may be an attractive feature to parents of teenage or young drivers whose parent or other related party may be interested in their driving safety to ensure the user is not operating the mobile device while operating the vehicle.

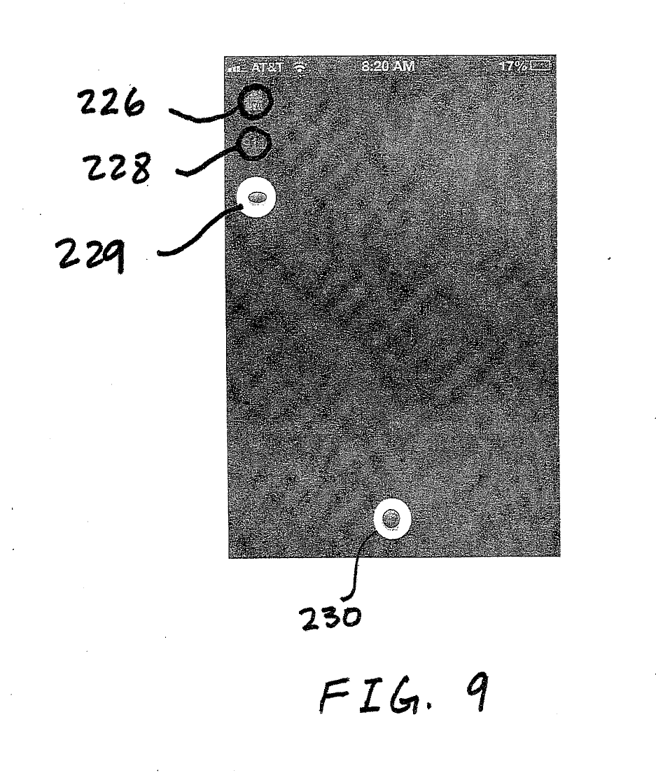

While the Application 200 is monitoring user's driving experience, the Application 200 may be configured to provide selectable features based on user preferences. For example, as illustrated in FIG. 9, during the monitoring step 308 of method 300, the Application 200 may be configured to provide a return home prompt or object 226 which the user may select to return to the home page 212. In addition, or instead, the Application 200 may be configured to provide an emergency prompt 228, for example a 911 dialing prompt, for instructing the processing unit to prompt the mobile device or other processing system to make an emergency phone call or other contact, which is user selectable or automatic based on other parameters, such as time-elapsed and/or degree of accident impact detected through the processing system's accelerometer, in cases of an emergency,

Such an embodiment of the present disclosure is not limited by the particular application in which the user may elect to exercise the option to select an emergency option. For example, in one embodiment, the emergency prompt 228 may facilitate the processing unit directly dialing 911 and connecting the user to a 911 respondent. In other embodiments this or another emergency prompt(s) may connect the user to another recipient of a phone call, e-mail, text, or other configurable communication option. In yet other embodiments, this or another emergency prompt 228 may launch another application on the mobile device such as the maps or other global positioning system (“GPS”) oriented application. For example, the processing system's GPS, accelerometer, and/or digital compass can feed location and orientation information to the processing unit, which in turn can be used by the user to identify his/her location and orientation, and/or electronically communicate such information to a destination such as an e-mail address, preset recipient destination electronic address, a remote server such as an emergency respondent server, and/or any other suitable electronically and/or wirelessly communicable destination.

In another example embodiment, location data, accelerometer data, and/or other information may be continually recorded, stored locally, or transmitted to another location.

In addition, or instead, in some aspects the Application 200 may include a record button 230, allowing user to pause and/or resume recording and/or monitoring driving experience. In some aspects, the recording function may utilize feeds from one or more cameras such as, for example, one or more front and/or rear cameras, or one or multiple same side cameras, and/or feeds from both on-device and external device feed capture mechanism.

Other expedient communication facilitating features may be incorporated in other embodiments. For example, in one embodiment, the emergency or help-communicating feature may be prompted and/or accessed from the home page 212 (FIG. 6). The Application 200 may be configured to allow the user to quickly recognize and access the help or emergency prompt 216. For example, an icon and/or user-selectable object, such as a graphic or text object, including a phone illustration and/or text such as “Call Help” may be used for user's visual assistance. Such a feature can be user selected according to user selection and processing system interactions discussed with respect to an embodiment toward the end of this disclosure.

In some embodiments, the Application 200 may include a panic or emergency button or object 229, which if selected by the user, the Application 200 instructs the processing unit to submit an emergency message with video feed recorded from a first duration prior to the user selecting the object 229 up to a second duration following the user selecting the object 229. In one embodiment, the Application 200 may be configured to submit the video feed only after the user selects the object 229 again to allow manual control over the recording length. Submittal of information can include location, video feed, and/or other information, as later discussed in context of information submittal following an accident. Such a feature maybe useful where an incident has not occurred, however, a disturbing or violent event is being carried out against the user or a third party and the user wants to quickly communicate this emergency situation.

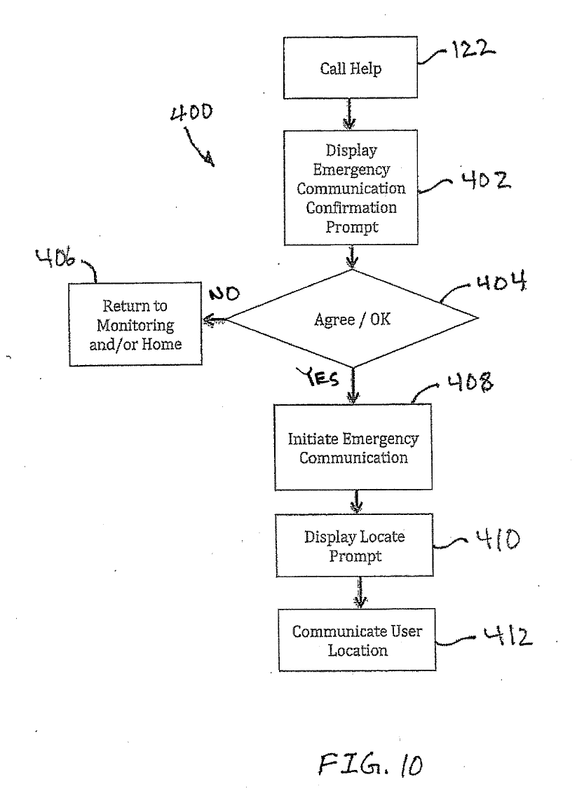

In some embodiments, the present disclosure may include a method 400 as illustrated in FIG. 10 for prompting for and/or implementing emergency communication when the user selects the call help prompt 216. The Application 200 may be configured to instruct the processing unit to automatically dial, connect to, and/or communicate with, 911 respondent, or other user-configured or Application-configured destination such as specific individuals from the user's contact list in the processing system, or, in case of delivery or other service providers, the closest other service provider to facilitate continued delivery or transport.

In another embodiment, any recorded information may be locally stored or transmitted for remote storage.

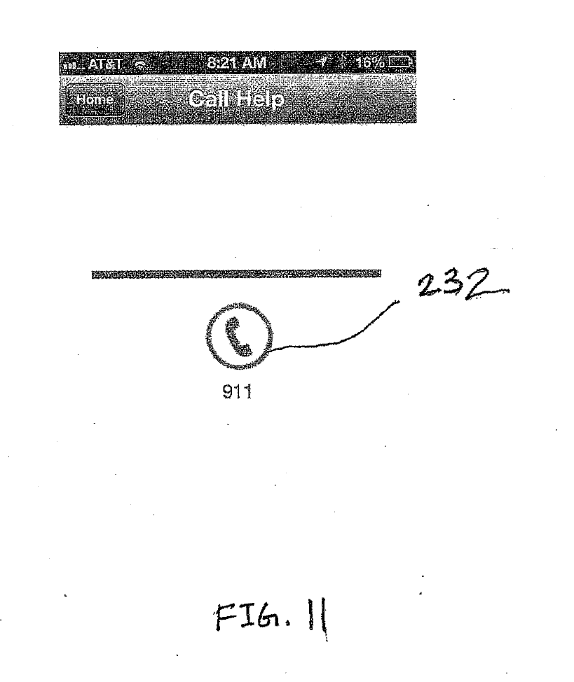

In yet other embodiments, as illustrated in FIGS. 10 and 11 the Application 200 may be configured to introduce an intermediate prompt, to display an emergency confirmation prompt 232 at step 402 of method 400. Such a measure may be implemented to prevent or reduce the chances of the user accidentally selecting the call help prompt 216 without the intention to reach emergency communication.

In one aspect, upon the user selecting the emergency communication confirmation prompt 232, at step 404, the Application 200 can be configured to instruct the processing unit to initiate the emergency communication, at step 406, to either a 911 respondent and/or other emergency response destinations which may be user or Application 200 configured in advance. Alternatively if the user does not confirm intention to initiate emergency communication the Application 200 may terminate, or leave termination or return to monitoring or home as the only user selectable or automatically directed option, at step 406 of method 400.

In some embodiments, the Application 200 may instruct the processing unit to through the phone component and/or some other communication method or independent device initiate an emergency contact if the user does not confirm or cancel the above-mentioned conformation prompt 232 with user location and/or accident details as described elsewhere herein, just in case the user by this time is not able to due to injuries or other reasons.

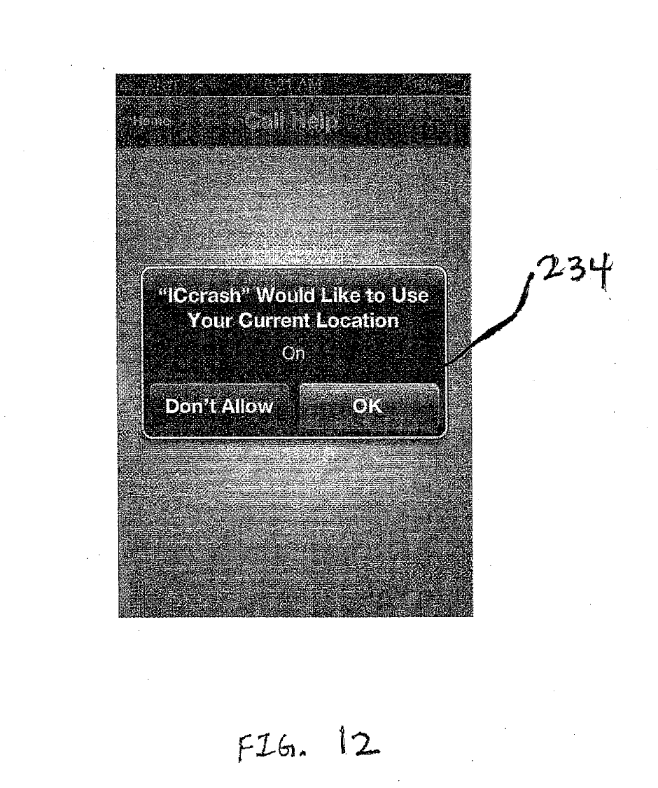

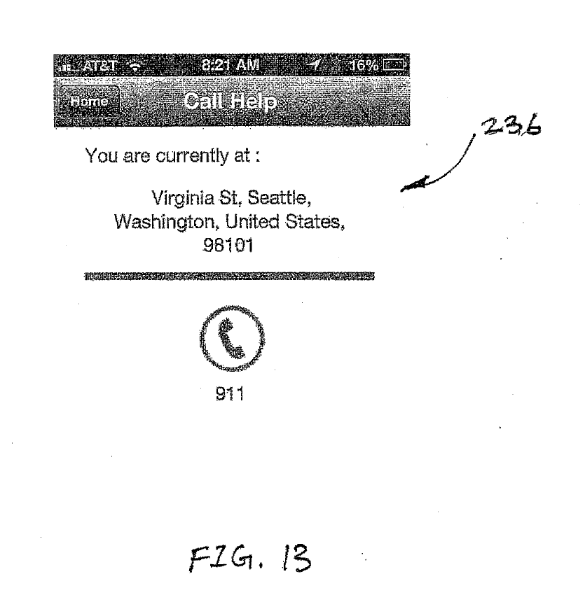

In some embodiments, the Application 200 can be configured to provide other emergency aid features. For example, in one embodiment, the method 400 may include a step 410 to instruct the processing unit to operate and provide the user the option to be located by an emergency respondent or other intended recipient. For example, as illustrated in FIG. 12, the Application 200 may be configured to instruct the processing unit to operate and display a locate prompt 234 at step 410, and if the user selects it, the Application 200 can be configured to then instruct the processing unit to submit a signal to communicate user location at step 412, to the emergency respondent or other intended recipient, for example via an address 236 or other map feature or GPS coordinate, as shown in FIG. 13, or through any other method such as for example transmitting a recorded portion or recorded landmark or some other identifying means such as closes street sign or intersection. As discussed further above, such information and/or other relevant information can be electronically and/or wirelessly be communicated between the processing system and a remote destination, such as a remote server.

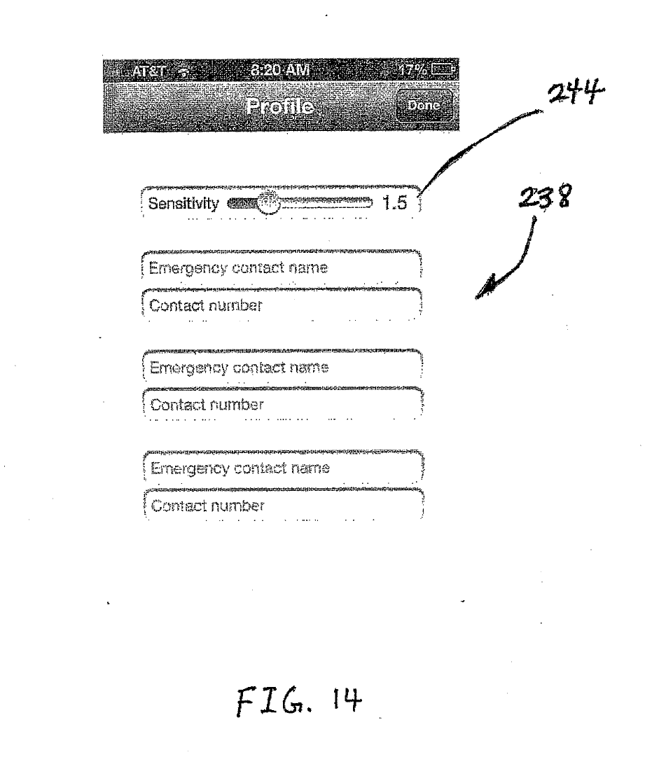

User-specified information to support alternate emergency communication recipient contact or for other reasons as described further below or as may be beneficial or appropriate in various applications, may be entered by the user through the profile prompt 218 from the home page 212 (FIG. 6). For example, in one aspect as illustrated in FIG. 14, once the user selects the profile prompt 218, the Application 200 can be configured to instruct the processing unit to display and/or to supply at least one, and in some embodiments, a plurality, of emergency contact name and contact information fields 238. Upon a user populating and saving such information, for example using the processing system's memory and/or an accessible remote device or server, the Application 200 can be configured to electronically and/or wirelessly communicate such information to a remote server and/or a central database where such information is stored, corresponding to the particular user's account against which such information was submitted.

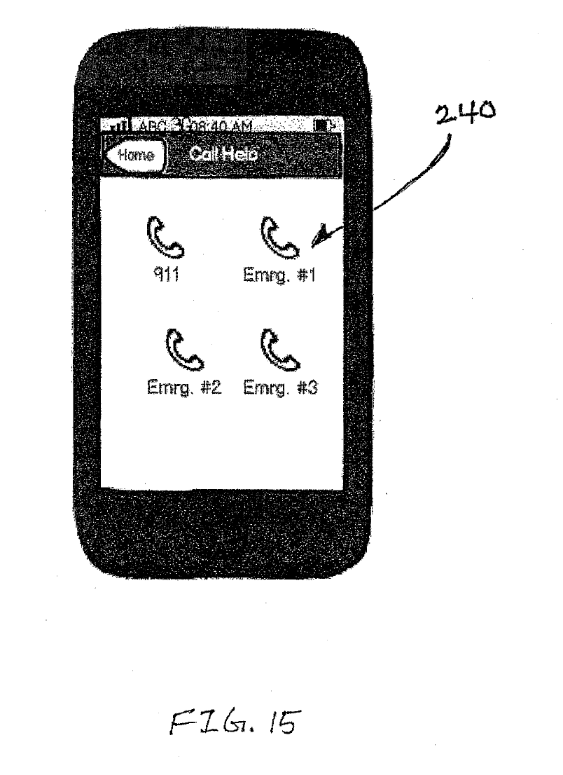

In some embodiments, when the call help prompt 216 is selected, the Application 200 may be configured to instruct the processing unit to provide the user the option of calling any one or more of the emergency contacts 238, and/or 911, as illustrated in FIG. 15 contact options prompt 240.

In some embodiments, when the user selects the emergency communication confirmation prompt 232, the Application 200 can be configured to instruct the processing unit to submit to the emergency respondent or any other user or Application configured recipient a written, audible, and/or other digitally or electronically or wirelessly communicable message, including a configurable and/or preprogrammed set of information. For example, in one embodiment such an emergency message may include the following contents:

### Subject Line:

### 911 Call Report—Policy Number: [POLICY NUMBER]

### Body of Message:

Date: [Insert date in mm/dd/yyyy format]

Time: [Insert time in xx:xx AM/PM format]

Location: [Insert device's location at the time of button push]

Driver name: [Insert driver's first and last name from the user's profile data]

Company: [Insert CompanyName from toptop.xml]

Vehicle number: [Insert vehicle number from user's profile]

Incident type: The driver has called 911

In some embodiments, such a message may in addition, or instead, include photo or video image files attached to the message, informing the recipients of parameters surrounding the emergency, which among other incidents or situations, may include an accident. For example, the Application can be configured to instruct the processing unit to operate and submit an image or video feed to a remote destination, such as a contact's electronic address and/or a remote server, or any other suitable destination. This can be configured to occur automatically and/or via user selectable objects through the Application 200 settings. This concept is explored in more detail below with respect to some embodiments.

According to one aspect, the Application 200 may be configured to detect an emergency situation such as an accident; moderate and/or terminate immediately or after a set duration, recording images and/or videos; and enter into post-accident reporting functionalities.

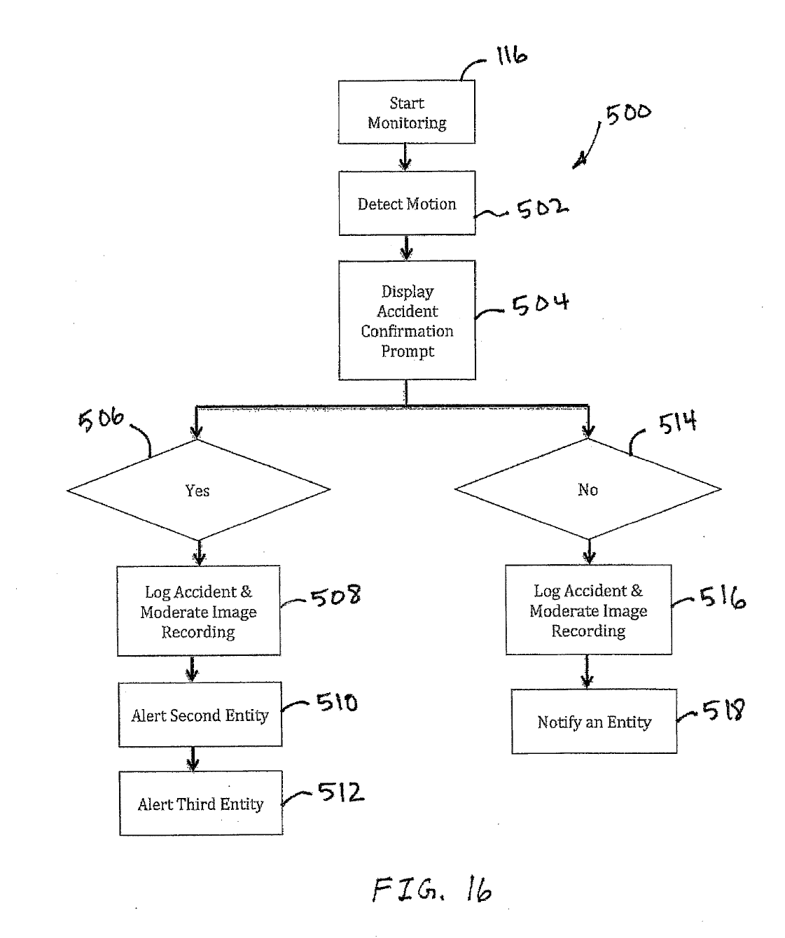

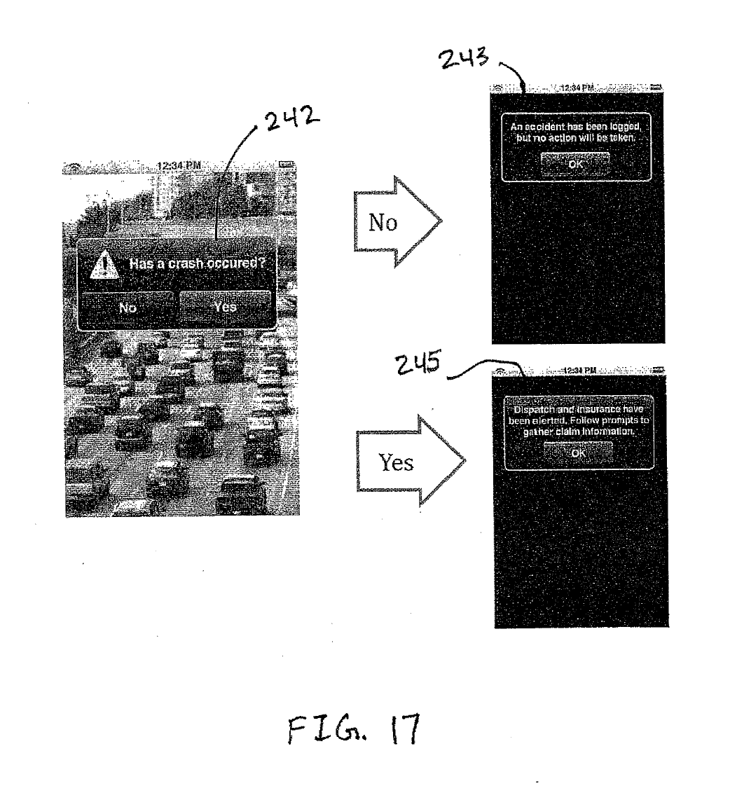

For example, in one embodiment as illustrated in FIGS. 16 and 17, a reporting method 500 may include a detect motion step at 502, following the Application 200 starting monitoring at 116. The Application 200 can be configured based on the mobile device operating system platform's motion detection and/or gyroscopic devices and/or accelerometer and/or digital compass, to detect motion at step 502, followed by displaying an accident confirmation prompt at 504, such as for example the prompt 242 illustrated in FIG. 17. The accident confirmation prompt 242 can among other notifications or accident verification messages, instruct the processing unit to recite and/or display a message, such as “Has a Crash Occurred?”

In one aspect, at this juncture, the user has the option of verifying an accident has occurred by clicking and/or touch selecting the confirmation or positive user interface prompt and/or object at step 506, such as for example, a “Yes” prompt and/or object. In another aspect, the user may verify the accident using voice, eye movement, gesture or any other input method.

In one embodiment, when the user selects the positive or “Yes” prompt or object at 506, the Application can be configured to instruct, and/or in concert with the processing unit, log and/or save to memory or temporary memory accident details such as time, impact magnitude, speed at impact, location and/or orientation, and/or any other relevant information, and moderate image recording at 508. For example, the Application 200 can be configured to instruct the processing unit to operate the processing system's image recording device to continue recording until the positive prompt is selected or continue recording for a duration following selection of the positive accident confirmation prompt. The Application 200 in one aspect can be configured to instruct the processing unit to display on the monitor of the processing system an accident log confirmation message 245 as shown in FIG. 17.

In one aspect, the Application 200 can in addition, or instead, be configured to alert one or more parties, persons and or entities at 510 and 512. For example these entities can be identified in advance as discussed above in relation to emergency contact personal settings. In addition, or instead, the alert recipient entities can be programmed for commercial customers who wish employee accidents immediately reported to the company, the insurance company, a dispatch center, and/or any other relevant party having a stake in the incident at hand. In some embodiments the Application 200 can be configured to instruct the processing unit to communicate with a text messaging application to submit via SMS or other protocol text messages to the identified or predetermined destination such as any of the foregoing recipient examples. Such text messages can in some embodiments be preset or user-entered and saved. This for example can be beneficial where internet connectivity is limited or otherwise not available. In some embodiments, any of the communications described herein can be accomplished via text messaging. In another aspect a voice message utilizing a device's text-to-talk or other mechanism may be generated and stored or transmitted.

In one aspect, the Application 200 can be configured to instruct the processing unit to simply terminate the Application 200 or return to monitoring driving experience in the event the user selected the negative or “No” prompt, in response to the accident confirmation prompt at 504. In another embodiment, as shown in FIG. 16, if a user selects the “No” or negative prompt at 514 in response to an accident confirmation prompt, such as whether an accident has occurred as shown in the prompt 242 in FIG. 17, the Application 200 can be configured to instruct the processing unit to continue and log accident details enumerated above, and/or notify an interested party or entity, such as for example any of the aforementioned entities, that a user entered a negative response to an accident confirmation prompt. The Application 200 in one aspect can be configured to display an accident log confirmation without any further action message 243 as shown in FIG. 17.

Such a function may be advantageous in commercial settings where for example a dispatch center or an employer wishes to verify the motion detection by Application 200 was indeed not an accident. Same advantage may be had in residential settings where a parent, a teacher, or other authority figure may be interested in confirming the user was honest in dismissing the Application 200 motion detection.

In some embodiments, if the user does not select the positive or negative prompts, the Application 200 may still be configured to whether immediately or otherwise go through the steps associated with the positive prompt just in case the user is unconscious or otherwise unable to interact with the processing unit.

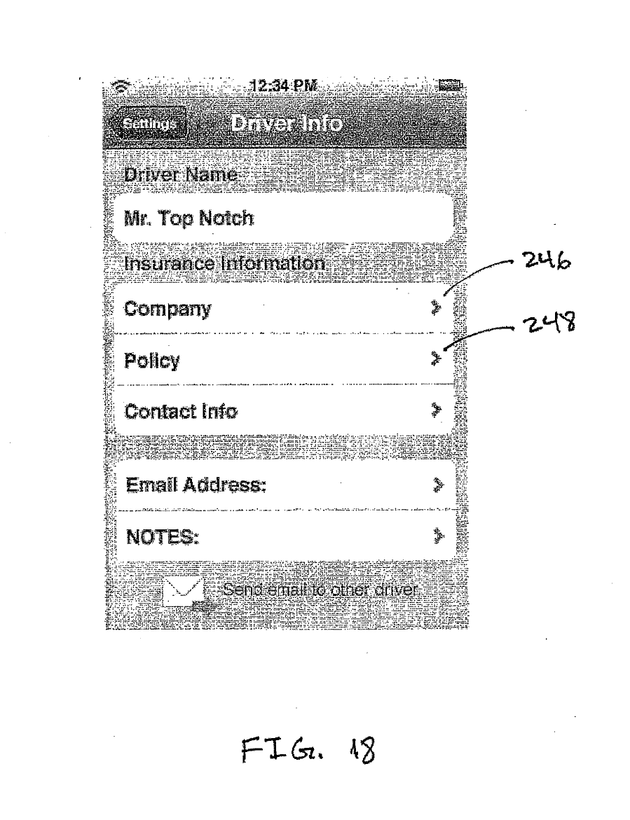

In an embodiment, user specific information facilitating the foregoing reporting measures, may include, among other things, user company information 246 and/or insurance policy information 248, as shown in FIG. 18. Such information can be user entered and/or accessed through the profile prompt 218 of home page 212.

Therefore, the insurance company will immediately have objective, timely, accurate, and complete information for expediently processing a claim, and/or the company or dispatcher has timely and accurate information to begin remedy measures including coordinating driver care and authority involvement, and business related measures such as monetary planning, insurance coordination, and vehicle maintenance record updating.

In one embodiment, the Application 200 may be configured to allow customizations. For example, in one aspect, through the profile prompt 218 (FIG. 6) the user may be provided user-selectable parameters to customize how the Application 200 operates. For example, in one aspect, the Application 200 may be configured to allow the user to specify what magnitude motion detection would trigger the processing unit to consider the motion an accident event, and proceed to subsequent accident verification steps described above.

For example, in one aspect, as illustrated in FIG. 14, the Application 200 may include a user-selectable parameter such as a sensitivity parameter 244 which the user may adjust for example via sliding a selectable prompt 246 from left to right to set a particular impact and/or motion detection sensitivity for the Application 200 to be operable and proceed to the accident verification steps. The Application 200 may be configured to have a protocol that uses the device accelerometer or sensing component to trigger an incident based on the user's particular preference for sensitivity. A user may elect to adjust such a parameter to calibrate for road conditions, vehicle type, or handheld device mount type, all of which may introduce vibrations or movement unrelated to an accident.

In some embodiments, the Application 200 can be configured to instruct the processing unit to facilitate a recording sequence and/or overwrite properties that promote efficient mobile device recording storage attributes. Despite mobile devices improving in hardware and software size and efficiency over time, reducing mobile device size and increasing mobile device storage capacity remain conflicting design parameters. Furthermore, mobile device users increasingly have image capturing and/or moving image recording demands from their mobile device. Therefore, applications intended to record images and/or moving images can benefit from accomplishing their intended purpose while reducing the amount of memory and or mobile device storage capacity required.

In some embodiments therefore the Application 200 may include an image or moving image recording protocol that reduces, minimizes, and/or eliminates over-recording, to reduce the storage requirements for the Application 200 to operate.

For example, in one embodiment, the Application 200 may include a routine or subroutine or other computer readable code, allowing constant recording while purging and/or deleting unwanted or unproductive recording portions.

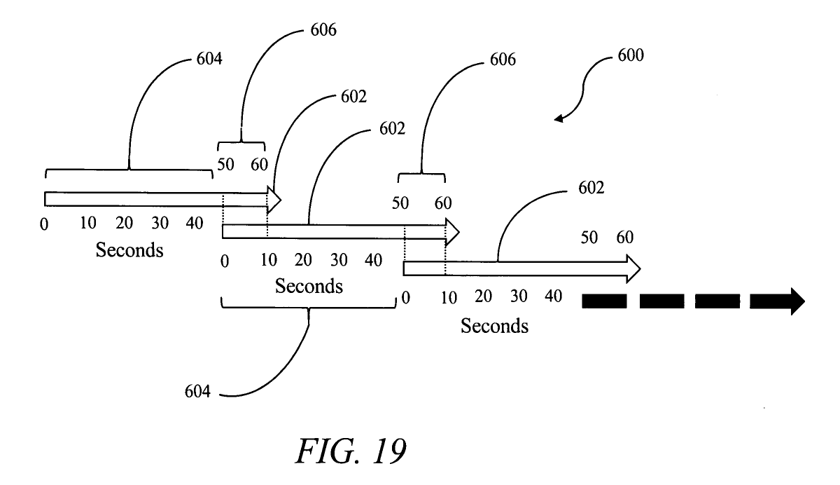

In one aspect, as illustrated in FIG. 19, a recording truncation method 600 configured to be implemented by the Application 200 may include a protocol to instruct the processing unit to operate the image recording device or camera to record in multiple overlapping cycles 602. In such an embodiment, for example, when a subsequent recording cycle begins a previous recording cycle is at least partially truncated, purged, and/or deleted in non-overlapping recording regions.

For example, in an aspect illustrated in FIG. 19, each recording cycle 602 can include a first duration 604 and a second duration 606. In one aspect, the second duration 606 of a recording cycle 602 can coincide and/or overlap with at least a portion of the first duration 604 of the subsequent recording cycle 602. In an embodiment, the Application 200 can be configured to delete the first duration 604 of the previous recording cycle 602, or a portion thereof, while maintaining at least the overlapped duration until the next recording cycle 602 begins.

In the above example, when the next (or third) recording cycle 602 begins, the aforementioned pattern continues, therefore, allowing the Application 200 to continuously record while purging uneventful footage, such as footage captured during times that an accident does not occur. In this manner, the Application 200 recordings will not miss any event of interest such as an accident while at the same time not consuming valuable mobile device storage.

In one aspect, the first and second durations may be pre-established by the Application 200. In one aspect, the first and second durations may be user-selectable.

In one embodiment the first duration is 50 seconds and the second duration is 10 seconds. Other durations are contemplated to be within the scope of the present disclosure. For example, in one embodiment, the first duration may be 10 seconds as well such that a total of 20 seconds are on memory at all times until the Application 200 is terminated and/or the video feed is communicated after an accident.

In one aspect, the Application 200 can be configured to instruct the processing unit to record video feed from camera on one or more memory type, such as RAM, on a processing unit for the above durations, then delete history past some duration, such as 10 seconds or other duration, from memory while keeping some history to have footage of an unanticipated event.

In yet another aspect, the Application 200 can be configured to record in low resolution or record only objects of identifying information.

Various embodiments of the present disclosure can include other features which may allow the user to control Application operation for example to be configured to display user-selectable prompts on the GUI of the mobile device. For example, the Application may display a user-selectable prompt for the user to be able to control when recording may stop and/or restart, for example in a case where the user may be parked or stopped for some reason.

In some aspects, there may be a panic report user-selectable prompt where the user can select the prompt to report a panic or emergency situation. The Application 200 may be configured in such situations to instruct the processing unit to extend the length of video recording to either a user-selectable length previously specified in user preferences and/or a predetermined Application coded length, to capture images while the emergency situation is ongoing.

In such an instance, the Application 200 can be configured to trigger the processing unit to use the processing system's electronic mail application to e-mail the recorded emergency footage to a destination such as a remote server, an emergency respondent and/or concerned recipients, whose contact information are preset in the Application 200 user preferences as described earlier with respect to the Application user setting up the profile information.

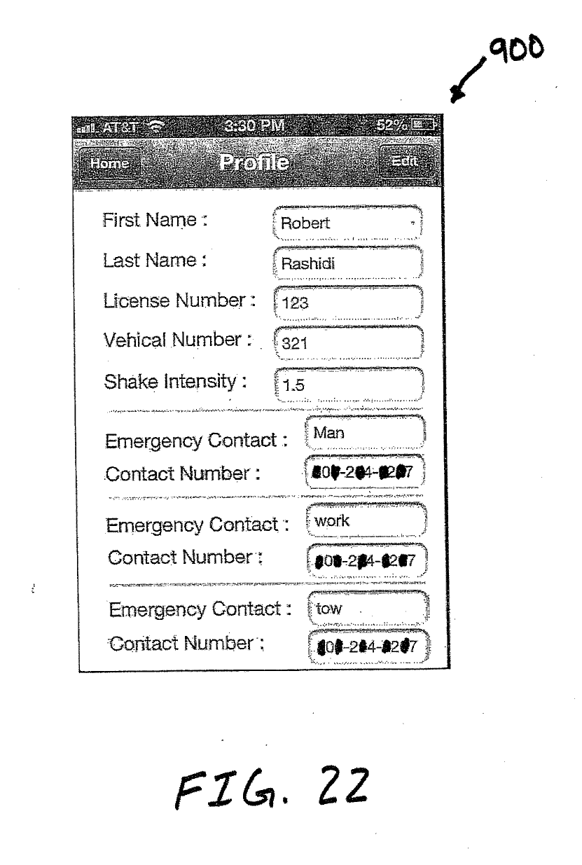

FIG. 22 is one example of an embodiment showing user-selectable presets in the Application settings, for example one or more emergency contacts, user and vehicle information, sensitivity setting, recording settings, such as duration lengths for recording feeds discussed above.

Appendices A and B include embodiments of an Application for monitoring, recording, and reporting a travel experience of a user.

Throughout the present disclosure reference to “prompt” includes “object” or “objects” such as graphic objects or other displayable visual component for a user to opt to select.

Throughout the present disclosure reference has been made to a processing system, which for example can include a computer, a handheld communication device, a mobile device, or any other processing system. Embodiments of an Application according to the present disclosure can be one or more protocols and/or programs that the processing system can read and follow instructions therefrom.

Embodiments of the present disclosure including described and not described embodiments and aspects of an image recording, monitoring, and reporting methods can be implemented using a computing and/or processing system such as for example a computer, laptop, and/or handheld or mobile communication device. Without any intention to limit the scope of the present disclosure, the following describes for clarity an example architecture and device components which can facilitate the foregoing interaction with Application embodiments of the present disclosure.

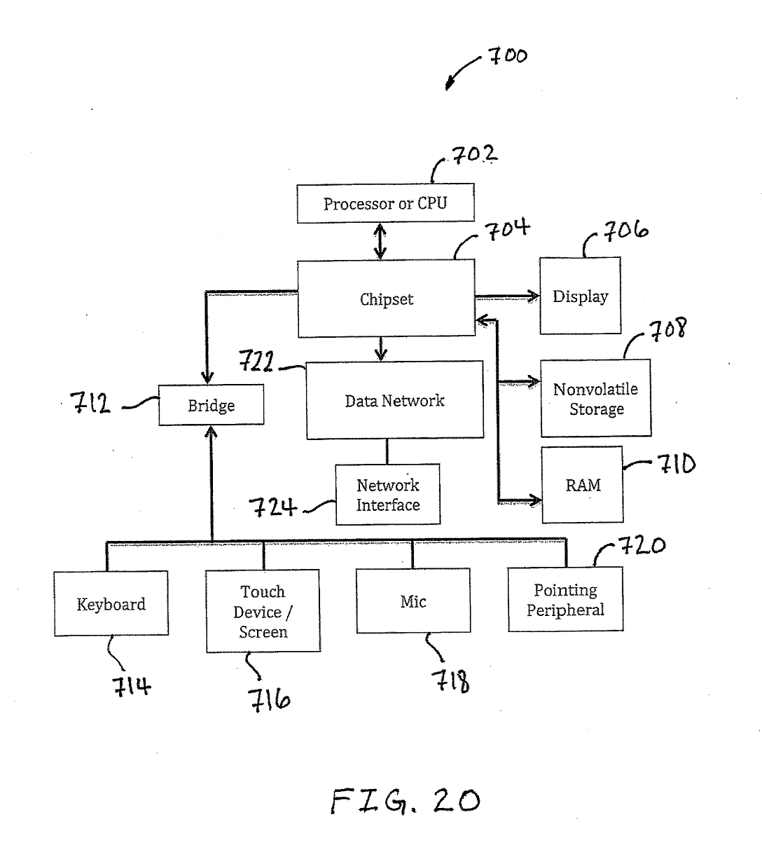

For example, FIG. 20 illustrates a processing system architecture 700 which can be used to execute a method according to described or undescribed embodiments of the present disclosure. For clarity of description the processing system will be referred to as “computer” without any intention to limit the particular processing system type which a user may use a method according to embodiments of the present disclosure.

Computer 700 is an example of computer hardware, software, and firmware, and includes a processor 702. The processor or processing unit 702 can represent one or more physically and/or logically distinct resources operable to execute software, firmware, and/or hardware configured to perform computations. Processor 702 can be configured to communicate with a chipset 704, which in turn is operable to manage input to and output from processor 702. In one aspect, the chipset 704 is operable to output information and/or graphics to display or monitor 706 and can read and write information to non-volatile storage 708. Non-exhaustive list of non-volatile storage can include magnetic media and solid state media, for example, read-only memory, flash memory, ferroelectric RAM or F-RAM. The computer 700 may also include volatile storage 710 such as random access memory (RAM), DRAM, SDRAM, SRAM, or other volatile storage. For clarity of description the volatile storage will be referred to as “RAM” without any intention to limit the type of volatile storage for devices executing embodiments of the present disclosure.

Chipset 704 in one aspect is operable to read data from and write data to RAM 710. The computer 700 may in one aspect include a bridge 712 and operable to interface with a user interface component, which can be provided for interfacing with chipset 704. Nonlimiting examples of user interface components can include a keyboard 714, a touch detection and processing circuitry 716, a microphone 718, a pointing and/or selecting peripheral device 720 such as a mouse or stylus, or any other user interface. Inputs to computer 700 can come from any of a variety of machine-generated and/or user-generated sources.

In some computers 700, the chipset 704 may interface with one or more data network interfaces 722 that can have different physical interfaces 724. Such data network interfaces 724 can include interfaces for wired and wireless local area networks, for broadband wireless networks, as well as personal area networks. Some applications of a method according to an embodiment of the present disclosure can include receiving data over physical interface 724 or be generated by the computer 700 itself by processor 702 analyzing data stored in memory 708 or RAM 710. In some examples, the computer 700 can receive inputs from the user via devices keyboard 714, microphone 718, touch device 716, and pointing device 720 and execute appropriate functions, such as browsing or other functions discussed above with respect to Application 200 functionality by interpreting these inputs using processor 702.

It is understood that other system architectures can be used with the present technology. For example, some or all the components described above can be joined to a bus, or the peripherals could write to a common shared memory that is connected to a processor or a bus can be used. Other hardware architectures are possible and such are considered to be within the scope of the present technology.

In some embodiments a system can be embedded such as for example in a black box or smart vehicle location, or in a vehicle's communication or safety system.

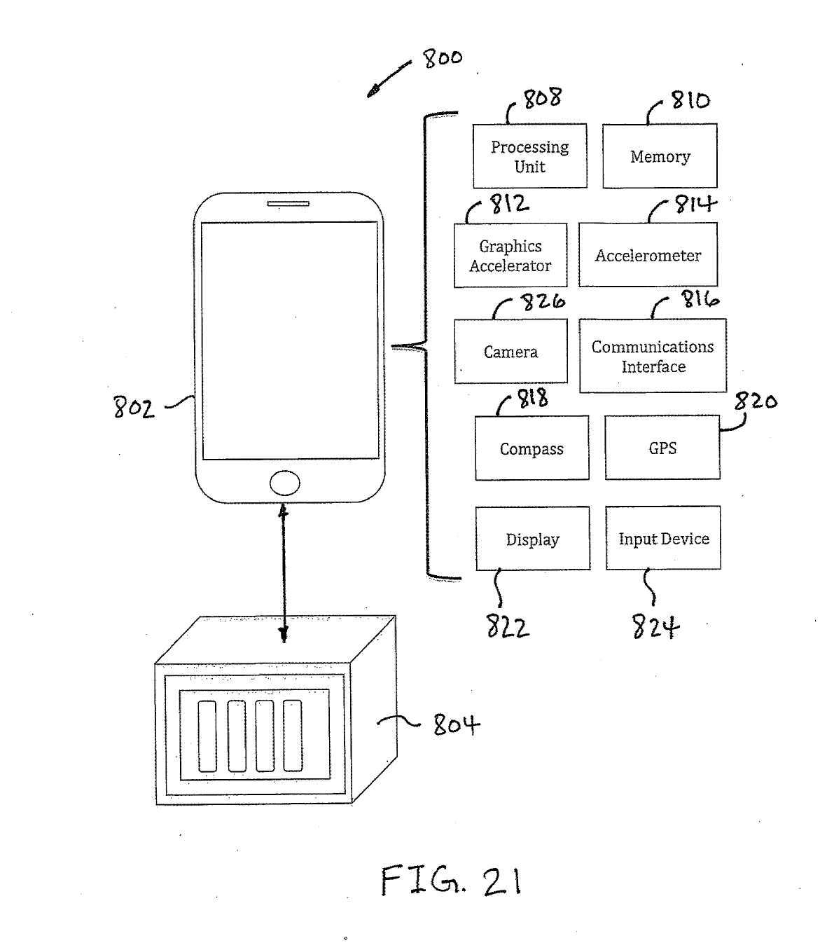

FIG. 21 illustrates an example system embodiment including a handheld communication device 802 and a server 804. For clarity of description, the handheld communication device 802 will be referred to as “mobile” without any intention to limit the type of device which can be used to execute embodiments of the present disclosure.

The server 804 can be in electronic and/or wireless communication with the mobile 802 having functional components such as a processing unit 808, memory 810, graphics accelerator 812, accelerometer 814, communications interface 816, compass 818, GPS 820, display 822, input device 824, and camera 826. It is understood that a device which a user can utilize to execute embodiments of methods according to the present disclosure are not limited to these components. The components may be hardware, software, firmware, and/or any combination thereof

In some embodiments, the server 804 can be separate from the mobile 802, and the server 804 and mobile 802 can communicate wirelessly, over a wired-connection, or through a mixture of wireless and wired connections. The mobile 802 can communicate with the server 804 over a TCP/IP connection. In addition, or instead, the mobile 802 can be directly connected to the server 804. In an embodiment, the mobile 802 can act as a server and store relevant information locally.

In some embodiments, instructions can be input to the mobile 802 through the input device 824 which in turn instructs the processing unit 808 to execute functions in a recording and reporting Application according to an aspect of the present disclosure. Such instructions can include any one or more of the instructions discussed above with respect to the recording and reporting methods according to various embodiments hereof. In an aspect for example, the processing unit 808 instructs the camera 826 to begin feeding video images to the display 822 and/or stream or otherwise electronically communicate the video feed according to the Application protocol as discussed further above with respect to some embodiments.

In some embodiments, video recorded by the camera are first sent to graphics accelerator 812 for processing before the images are displayed or submitted. In some embodiments, the processer 808 can be the graphics accelerator. The image can be first drawn in memory 810 or, if available, memory directly associated with the graphics accelerator 812.

The processing unit 808 in one aspect can also receive location and orientation information from devices such as a GPS device 820, communications interface 816, digital compass 818 and/or accelerometer 814, for example, for processing orientation-related functions described in relation to some embodiments above.

The GPS device 820 can determine GPS coordinates by receiving signals from Global Positioning System (GPS) satellites and can communicate them to the processing unit 808. In one embodiment, the processing unit 808 can determine the location of the mobile 802 through triangulation techniques using signals received by the communications interface 816. In an embodiment, the processing unit 808 can determine the orientation of the mobile 802 by receiving directional information from the digital compass 818 and tilt information from the accelerometer 814.

In one embodiment, the processing unit 808 can direct the communications interface 816 to submit a request to the server 804 for map data corresponding to the area surrounding the geographical location of the mobile 802 for example to initiate an augmented reality application to easily spot nearby hospitals, police station, or other location, or to better define the user's driving experience or accident details. In some embodiments, the processing unit 808 can receive signals from the input device 824, which can be interpreted by the processing unit 808 to be a search request data including features of interest. Such features may include any of the user-selectable or Application preset information such as emergency contacts, insurance information, and/or any other desired information which can reside on the server 804.

In some embodiments, the processing unit 808 can interpret the location and orientation data received from the accelerometer 814, compass 818, or GPS 820 to determine the direction in which the camera 826 is facing. Using this information, the processing unit 808 can submit orientation and location information to a destination such as an emergency respondent.

In some embodiments, the processing unit 808 can receive other inputs via the input device 824 such as inputs described with respect to methods according to various embodiments. The processing unit 808 can in some aspects interpret map data to generate, display, and/or submit to a remote destination a route over the displayed image for guiding the recipient such as an emergency responder to the user's location.

Methods according to the above-described examples can be implemented on processing units, for example, the steps associated with video feed would involve processing unit interaction as described above; those related to location information would involve processing unit communicating with GPS, Compass, Wi-Fi, and/or other relevant location identifying or enhancing component; those related to preset or pre-programmed settings and/or submitting information such as accident information can utilize the communication interface to send and receive information between the processing unit and the server, or save information on the server, and so on.

Methods according to the above-described examples can be implemented using computer-executable instructions stored or otherwise available from computer-readable media. Such instructions comprise, for example, instructions and data which cause or otherwise configure a general-purpose computer, a special-purpose computer, or a special-purpose processing device or system to perform a certain function or group of functions. Portions of computer resources used can be accessible over a network. The computer-executable instructions may be, for example, binaries, intermediate format instructions such as assembly language, firmware, or source code. Examples of computer-readable media that may be used to store instructions, information to be used, and/or information created during methods according to described examples include magnetic or optical disks, flash memory, USB devices provided with non-volatile memory, networked storage devices, and so on.

Devices implementing methods according to this disclosure can comprise hardware, firmware, and/or software and can take any of a variety of form factors. Typical examples of such form factors include laptops, smart phones, small-form-factor personal computers, personal digital assistants, and/or other form factors. Functionality described herein also can be embodied in peripherals or add-in cards. Such functionality also can be implemented on a circuit board among different chips or different processes executing in a single device.

The instructions, media for conveying such instructions, computing resources for executing them, and other structures for supporting such computing resources are means for providing the functions described in this disclosure.

Although a variety of examples and other information have been used to explain various aspects within the scope of the present disclosure, no limitation of the claims should be implied based on particular features or arrangements in such examples, as one of ordinary skill would be able to use these examples to derive a wide variety of implementations. Furthermore, and although some subject matter may have been described in language specific to examples of structural features and/or method steps, it should be understood that the subject matter defined in the appended claims is not necessarily limited to those described features or acts. For example, functionality of the various components can be distributed differently or performed in components other than those identified herein. Therefore, the described features and steps are disclosed as examples of components of systems and methods that are deemed to be within the scope of the claims.

Various embodiments of the present disclosure provide a means for a user or other party having interest in being informed about the travel experience of the user, providing objective evidence of the experience and leaving no room for speculation. In this manner, the actual events speak for themselves to minimize the cost of processing claims and reconciling conflicting reports of what actually occurred during an incident.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method configured to be implemented on a processing system having a processor, memory, and image-capture device, a motion sensing component, and a display, the method comprising:
capturing an image for a duration;
detecting a motion of a threshold magnitude; and
electronically submitting the captured image for at least the duration to a destination in response to detecting the motion of the threshold magnitude or upon a user-instructed event.

2. The method of claim 1 wherein the capturing step includes displaying a user-selectable object for initiating image capturing.

3. The method of claim 1 wherein the captured image is stored on the memory temporally and subsequent to submittal to destination, the captured image is deleted from the memory.

4. The method of claim 1 wherein the duration includes a threshold duration prior to the motion sensing component detecting the motion of the threshold magnitude until a threshold duration subsequent to the motion sensing component detecting the motion of the threshold magnitude.

5. The method of claim 1 wherein the threshold magnitude is a user-selectable magnitude.

6. The method of claim 1, further comprising:
detecting a geographic position of the processing system and electronically submitting the geographic position to the destination.

7. The method of claim 1 wherein the processing system includes a handheld communication device and the method further includes blocking incoming communication to the device.

8. The method of claim 1 wherein the capturing step includes capturing an image for a first duration and continuing to capture the image for a second duration, wherein upon beginning to capture the image for the second duration at least a portion of the image captured during the first duration is purged or deleted from memory.

9. The method of claim 1, further comprising:
displaying a user-selectable object to initiate communication with at least one destination such as an emergency respondent, upon detecting the motion of the threshold magnitude.

10. The method of claim1 wherein the user-selectable event includes the user selecting a manual submit object, subsequent to such selection the method including submitting image captured from a threshold duration prior to the user selecting the manual submit object to a threshold duration subsequent to the user selecting the manual submit object.

11. A system comprising:
a video capture device configured to capture video images;
a global positioning system (GPS) device configured to determine GPS coordinates identifying the location of the video capture device;
a motion detecting component;
a display;
a server for receiving and servicing requests for electronic communication such as electronic mail;
a general-purpose processor in digital communication with the video capture device, the GPS device, the motion and the display, the general purpose processor configured to digitally communicate with the video capture device to initiate capturing images for a threshold duration and to digitally communicate with the motion detecting component and upon detecting a motion of a threshold magnitude, the general-purpose processor is configured to electronically communication with the server to submit an electronic message comprising at least a portion of the captured image.

12. The system of claim 11 wherein the processor in cooperation with the video capture device limits the duration of the captured image submitted to a threshold duration of image capture prior to the motion detecting component detecting the motion to a threshold duration of image capture subsequent to the motion detecting component detecting the motion.

13. The system of claim 11, further comprising:
a graphics processor in digital communication with the general-purpose processor, wherein processer communicates with the graphics processor to display a user-selectable external communication object on the display upon the motion detecting component detecting the motion.

14. The system of claim 11, further comprising:
a memory unit in digital communication with the processor, wherein the processor communicates with the video capture device to capture images on the memory for a first threshold duration followed by a second threshold duration, the processor communicating with the memory unit to delete or purge at least a portion of the first threshold duration when the second threshold duration begins.

15. The system of claim 11 wherein the motion detecting component includes an accelerometer.

16. The system of claim 11 wherein the processor communicates with the graphics processor to display a panic or manual submit object on the display, upon selection of the panic object the processor communicating with the server to submit a threshold duration of the image captured by the video capture device via electronic communication.

17. The system of claim 11 wherein the processor communicates with the GPS device and the server to include in the electronic message GPS coordinates or location of the video capture device.

18. A method configured to be implemented on a processing system having a processor, memory, communication components, the method comprising:
capturing information for a duration;
detecting an incident; and
electronically storing or submitting the captured information in response to detecting the incident.
